(19) United States
(12) Patent Application Publication
(10) Pub. No.: US 2006/0159017 A1
(43) Pub. Date: Jul. 20, 2006

(54) Dynamic quality of service (QoS) management

(76) Inventors: Seung-Cheol Mun, Seongnam-si (KR); Sang-Cheol Lee, Yongin-si (KR)

Correspondence Address: Robert E. Bushnell;Suite300, 1522 K Street, N. W., Washington, DC, 20005-1202, US

(21) Appl. No.: 11/269,832

(22) Filed: Nov. 9, 2005

(30) Foreign Application Priority Data
Jan. 17, 2005 (KR) 2005-4299

(51) Int. Cl. H04L 12/26

(52) U.S. Cl. 370/230

(57) ABSTRACT

A dynamic Quality of Service (QoS) management apparatus includes: a management server having a database, the management server storing system performance information data collected from a network element (NE) system and dynamic user core management information generated by a user's selection in a table of the database; and a client manager to generate system performance information by referring to the dynamic core management information stored in the database and displaying a status information corresponding to the dynamic user core management information. The management for generating/modifying/deleting the new Key Performance Indicator (KPI) by performing the four rules of arithmetic on the different data (multi DB table attributes) can be performed without stopping the system operation such that the requirements for managing the QoS with compound characteristics due to various functions and policies of different standards can be satisfied.

### CLAIM OF PRIORITY

This application makes reference to, incorporates the same herein, and claims all benefits accruing under 35 U.S.C. §119 from an application for DYNAMIC QoS MANAGEMENT APPARATUS AND METHOD earlier filed in the Korean Intellectual Property Office on 17 Jan. 2005 and there duly assigned Serial No. 10-2005-0004299.

### BACKGROUND OF THE INVENTION

1. Field of the Invention

The present invention relates to a dynamic Quality of Service (QoS) management apparatus and method and, more particularly, to a dynamic QoS management apparatus and method to dynamically configure different system performance data so as to monitor and manage the system.

2. Background of the Related Art

Recently, QoS has been considered for wired and wireless network systems and efficient and stable QoS management has been a key issue.

QoS is a technique for managing heterogeneous traffic flows by classifying the services according to the priorities of the users or applications in a given bandwidth. QoS solution allows not only increasing the capacity of the network but also efficiently controlling and managing the traffic by monitoring and analyzing the traffic, resulting in the optimization of the network and an improvement of the network management scheme.

Accordingly, QoS management should be used to solve the collision and congestion of traffic of the users, realize profits of the service provider, and allow the subscribers to immediately check the service quality, such that it is significant factor for business.

However, QoS has compound characteristics with various technologies, functions, and polices depending on the recommendations of the plural network systems and various technologies exist for multiple layers such that it is not easy to manage QoS.

The conventional network management method based on such conventional QoS policy continuously monitors Key Performance Indicators (KPIs) that have a significant effect on the service management for maintaining the system performance and takes immediate action through a realtime analysis even when performance degradation occurs.

In the conventional network system management method, the KPIs are directly selected on the basis of various performance data collected from the system or computed from performance data values and can be managed in various manners according to the preference of the network system manager.

However, the conventional network system management method is not appropriate to select or generate such various KPIs but only can select system-dependent KPIs or provide a limited dynamic KPI generation algorithm.

Also, in the conventional QoS policy-based network system management method, all of the system data can not be managed within a single database table but only the performance data to be managed as KPIs within a particular database table such that it is impossible to generate dynamic KPIs during the operation.

Also, even though the limited dynamic KPI generation algorithm of a QoS policy-based network system management method can generate new KPIs through the four rules of arithmetic of the attributes in the database table, it is impossible to generate the KPIs using the various attributes belonged to different database tables.

Furthermore, since the conventional QoS policy-based network system management method has a system-dependent KPI selection algorithm, it is impossible to adopt the KPI selection algorithm to other systems and it is necessary to redevelop QoS tools having the identical function for every system.

### SUMMARY OF THE INVENTION

The present invention has been made in an effort to solve the above problems, and it is an object of the present invention to provide a dynamic QoS management apparatus and method to perform management processes such as Key Performance Indicator (KPI) creation, modification, and deletion to generate various KPIs requested by system operators without stopping the system operation.

Also, it is another object of the present invention to provide a dynamic QoS management apparatus and method using a QoS management algorithm even when a new system is developed.

In order to achieve the objects, in one aspect of the present invention a dynamic Quality of Service (QoS) management apparatus includes: a management server having a database, the management server adapted to store system performance information data collected from a Network Element (NE) system and dynamic user core management information generated by a user's selection in a table of the database; and a client manager adapted to generate system performance information by referring to the dynamic core management information stored in the database and to display status information corresponding to the dynamic user core management information.

In another aspect of the present invention, a dynamic Quality of Service (QoS) management method includes: generating dynamic user core management information by processing different system performance information data or attributes of the data using four rules of arithmetic and generating a KPI meta table in a database of a management server; storing the system performance information data collected from a Network Element (NE) system in real-time into a system collection table in the database; requesting a present status of the dynamic user core management information after the system performance information data has been completely collected; outputting a resultant value of the dynamic user core management information by combining the system performance information data according to the dynamic user core management information created in the KPI meta table; and displaying the status value of the dynamic user core management information corresponding to a resultant of comparison between the resultant value of the dynamic user core management information and the threshold value.

In another aspect of the present invention, a dynamic Quality of Service (QoS) management apparatus includes: a management server adapted to store system performance information data collected from a Network Element (NE) system and a dynamic user core management information Key Performance Indicator (KPI) generated by a user's selection, to store QoS error data in a respective table of a database, and to generate an alarm upon a QoS error occurring; and a client manager adapted to store the dynamic user core management information generated by the user's selection, to generate system performance information, requested by the user, referring to the KPI meta table after the system performance information data has been completely collected, and to transmit status information of the dynamic user core management information to the management server.

In still anther aspect of the present invention, a dynamic Quality of Service (QoS) management method includes: generating dynamic user core management information by processing different system performance information data or attributes of the data using four rules of arithmetic and storing the dynamic user core management information in a Key Performance Indicator (KPI) meta table of a database of a management server; storing the system performance information data collected from a Network Element (NE) system in real-time in a system collection table in the database; requesting a present status of the dynamic user core management information after the system performance information data has been completely collected; outputting a resultant value of the dynamic user core management information by combining the system performance information data according to the dynamic user core management information created in the KPI meta table; and storing or deleting or modifying the dynamic user core management information in an error management table as an error upon the status value of the dynamic user core management information as a result of the comparison between the resultant value of the dynamic user core management information and a threshold value indicating the error.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram of a dynamic QoS management apparatus according to a first embodiment of the present invention;

FIG. 2 is a detailed block diagram of the dynamic QoS management apparatus of FIG. 1;

FIG. 3A is a block diagram of a detailed structure of a user interface of the dynamic QoS management apparatus of FIG. 2;

FIG. 3B is a block diagram of an another structure of the user interface of the dynamic QoS management apparatus of FIG. 2;

FIG. 4 is a view of a display of dynamic user core management information of the dynamic QoS management apparatus of FIG. 2;

FIG. 5 is a flowchart of a dynamic QoS management method according to a first embodiment of the present invention;

FIG. 6 is a flowchart of a method of storing the dynamic user core management information in the dynamic QoS management method of FIG. 5;

FIG. 7 is a block diagram of a dynamic QoS management apparatus according to a second embodiment of the present invention;

FIG. 8 is a block diagram of an interface of the dynamic QoS management apparatus according to the second embodiment of the present invention;

FIG. 9 is a flowchart of a method of storing the dynamic user core management information of the dynamic QoS management method of FIG. 8;

FIG. 10 is a KPI meta table used in the dynamic QoS management apparatus of FIG. 1; and

FIG. 11 is a query to collect system performance information data used in the dynamic QoS management apparatus of FIG. 1.

### DETAILED DESCRIPTION OF THE INVENTION

The dynamic QoS management apparatus and method according to the first embodiment of the present invention is described hereinafter with reference to the accompanying drawings.

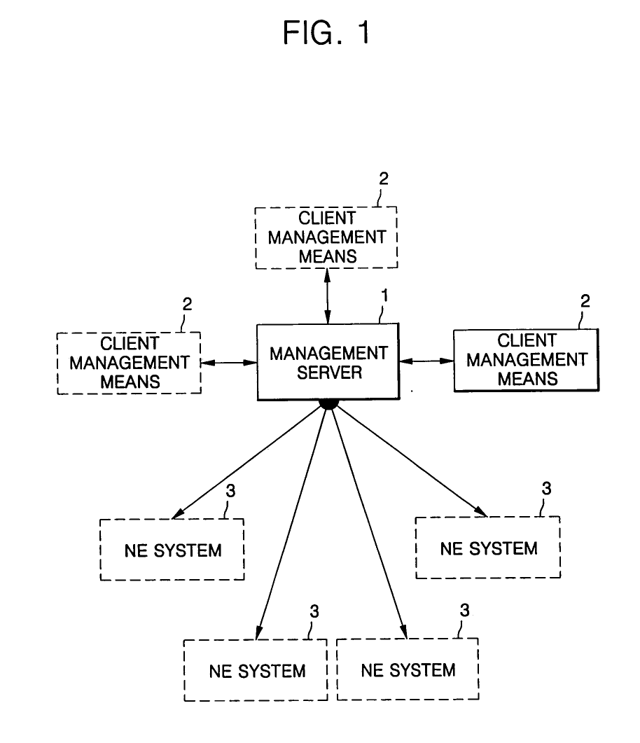

FIG. 1 is a block diagram of a QoS management apparatus and method according to a first embodiment of the present invention. As shown in FIG. 1, the QoS management apparatus includes a management server 1 to manage various data inputted from an NE system and a client manager 2.

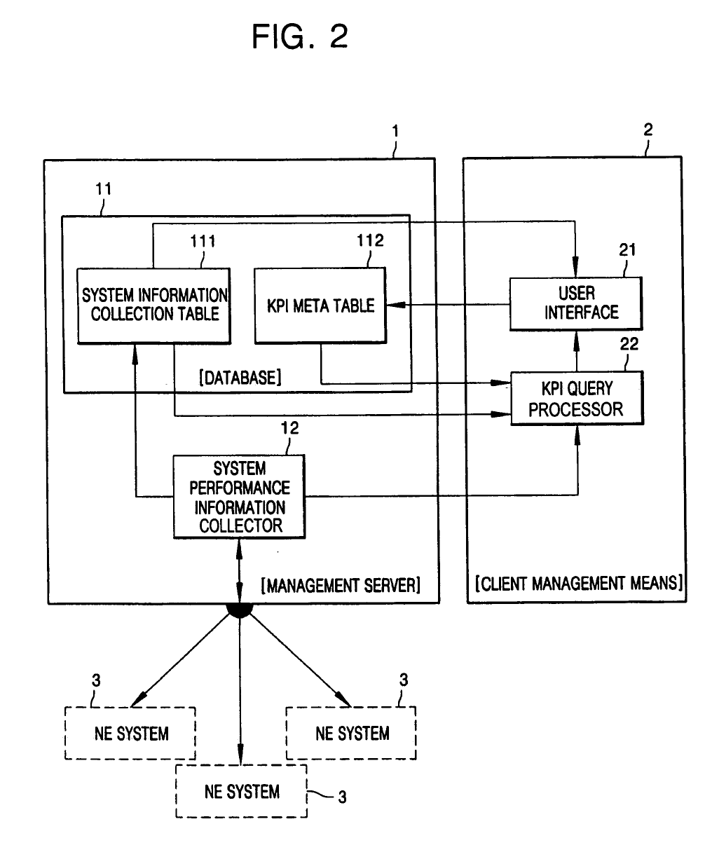

The management server 1 includes a database 11 and a system performance collector 12 (see FIG. 2). The management server 1 stores system performance information data collected from the NE system 3 and “dynamic user core management information” selected by the user in a table of the database 11. The dynamic user core management information includes a threshold value of the system performance information data.

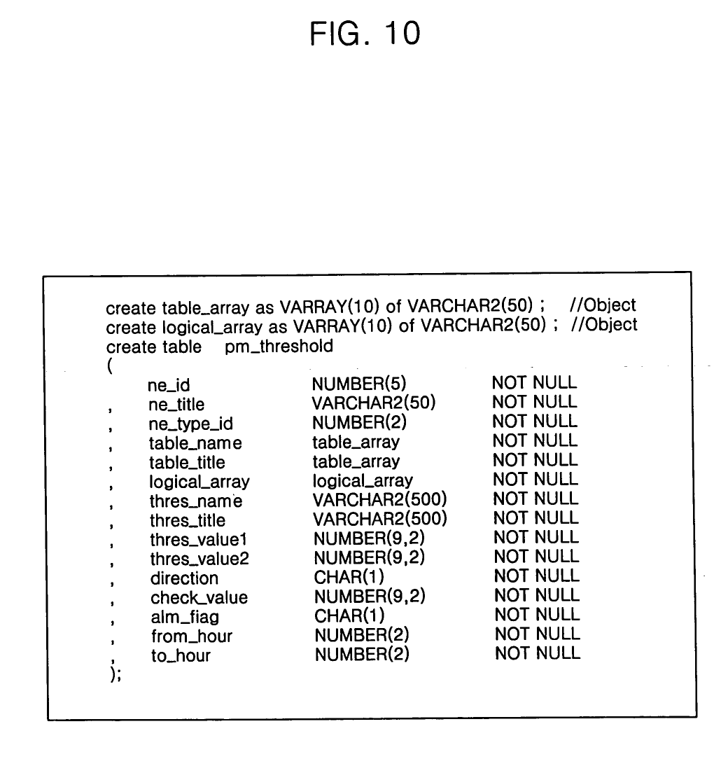

The database 11 of the management server 1 includes a system information collection table 111 for storing the system performance information data and a KPI meta table 112 for storing the dynamic user core management information generated from the client manager 2. The KPI meta table 112 of the database 11 includes at least a table name, a table list, and logical location defined as an array (see FIG. 10).

The system performance collector 12 collects the performance information data from the NE system 3 in real-time and stores the collected performance information data in the system information collection table 111 of the database 11. When the collection of the system performance information data has been completed, the system performance collector 12 transmits a “data collection completion signal” to the client manager 2. The system performance collector 12 collects the system performance information data in an extensible Markup Language (XML) file format.

The management server 1 further includes a QoS alarm event detector 13 which receives status information, i.e., “user core management information” from the client manager 2 and generates a QoS error alarm if the status information indicates a QoS error and simultaneously stores/deletes/modifies the status of the user core management information within an error management table of the database 11.

The client manager 2 includes a user interface 21 and a KPI query processor 22 (see FIG. 2) and stores the dynamic user core management information generated by the user selection in the database 11 of the management server 1. The client manager 2 generates the system performance information referring to the dynamic user core management information stored in the database 11 of the management server 1 and displays the dynamic user core management information as the status information after the system performance information data has been collected from the NE system 3.

The user interface 21 of the client manager 2 combines different system performance information data according to the user selection on the various information associated with the user core management information and stores the combined information in the management server 1. The user interface 21 includes a display 211, an arithmetic unit 212, an arithmetic register 213, a threshold configuration unit 214, a QoS alarm violation selector 215, and a KPI display 216. The user interface 21 is a Graphic User Interface (GUI) to display the performance information of the NE system 3 from the management server 1.

The display 211 of the user interface 21 includes a first region for displaying the system performance information data and their attributes and high level performance data of the NE system such that the user can select the different system performance information data, the attributes, and the high level performance data; and a second region for displaying low level attributes of the system performance inform data displayed on the first region.

The arithmetic unit 212 of the user interface 21 performs arithmetic processing of the attributes of the system performance information data selected by the user. Also, the threshold configuration unit 214 of the user interface 21 configures at least one threshold value so as to display the status of the dynamic user core management information selected by the user.

The QoS alarm violation selector 215 of the user interface 21 sets up the alarm or notifies the status when the value of the dynamic user core management information is greater than or less than the threshold value.

Also, the arithmetic register 213 of the user interface 21 registers or modifies the macro expression of the dynamic user core management information.

The KPI display 216 of the user interface 21 displays the label “user core management information” and the name used in the system to the operator.

Also, the user interface 21 compares the resultant value of the dynamic user core management information inputted from the KPI query processor 22 with the threshold value and then displays the status of the dynamic user core management information according to its level. The user interface 21 displays a “bad” indication when the resultant value is greater than the first threshold value, a “normal” indication when the resultant value is between the first and second threshold values, and a “good” indication when the resultant value is less than the second threshold value.

The KPI query processor 22 selectively combines the system performance information corresponding to the dynamic user core management information received from the management server 1 and then computes the resultant value of the dynamic user core management information, when the collection of the system performance information data has been completed. The KPI query processor 22 collects the different system performance information data from the database 11 of the management server 1 using an outer join for computing the resultant value of the dynamic user core management information achieved through the arithmetic four rules. Also, the KPI query processor 22 generates a query for combining the attributes of the system performance information data by referring to the user core management information of the meta table stored in the database 11 of the management server 1 and then collects the system performance information data corresponding to the query and stores the data in an Application Programming Interface/Java Application Resource (API/JAR) format.

The KPI query processor 22 outputs the resultant values of the dynamic user core management information when the data collection complete message has been received from the management server 1.

The operation of the above-structured dynamic QoS management apparatus is described hereinafter.

Firstly, the management server 1 stores the system performance information data collected from the NE system 3 and the dynamic user core management information combined according to the user's intention in the tables of the database.

The system performance information data collected from the NE system 3 is stored in the system information collection table 111, and the dynamic user core management information generated by the client manager 2 is stored in the KPI meta table 112.

The dynamic user core management information is inputted from the client manager 2.

The client manager 2 combines and displays the different system performance information on the display of the user interface 21 to generate the dynamic user core management information.

Accordingly, the user can select the different system performance information data or the attributes on the display 211 of the user interface 21. The system performance information data displayed on the display 211 is referred from the management server 1.

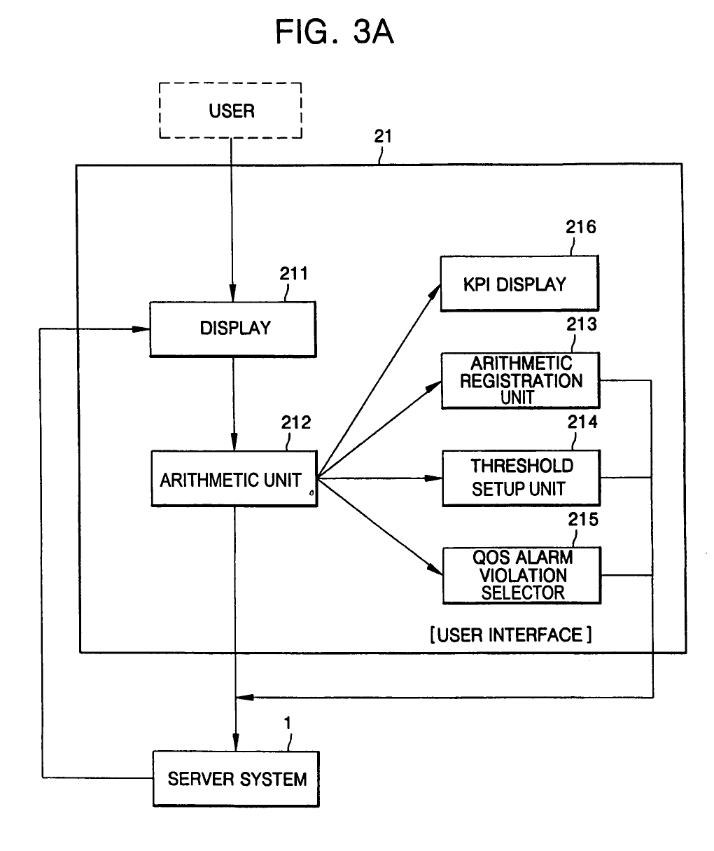

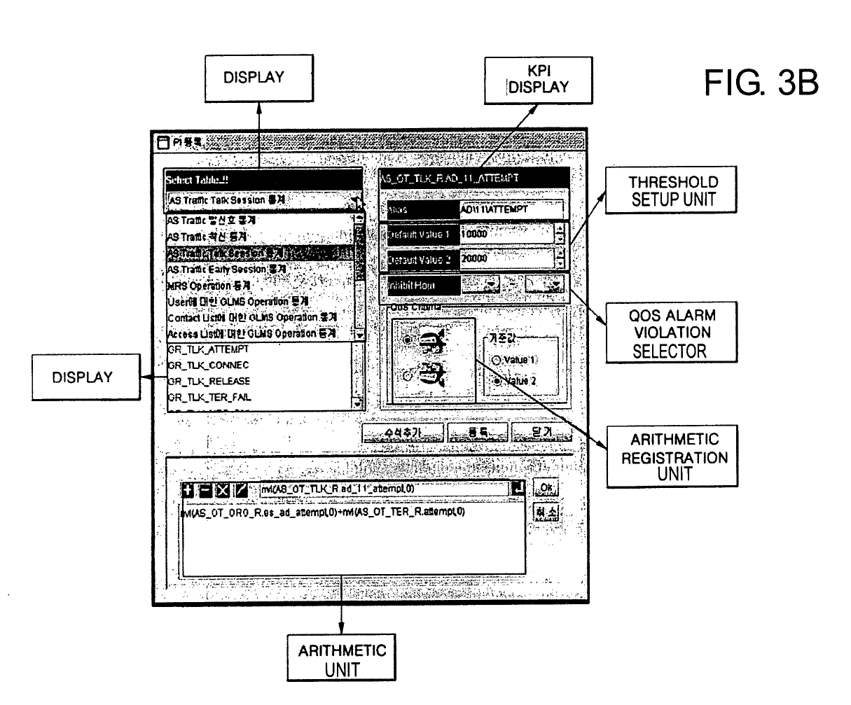

If the user selects the system performance information data “AS Traffic Talk Session Statistics” displayed in the first region of the display 211 shown in FIG. 3B, then the attributes of the data are displayed in the second region of the display 211.

If the user selects the attribute of the data displayed in the second region of the display 211, the attribute of the system performance information data is displayed in the arithmetic unit of FIG. 3B. By repeating this operation, it is possible to monitor the system performance requested by the user.

The user can register or modify the macro expression of the dynamic user core management information through the arithmetic register 213 of the user interface 21 and display the title of “user core management information” and its internal name on the KPI display 216 of the user interface 21.

Also, the user can set up more than one threshold value for expressing the status of the dynamic user core management information via the threshold configuration unit 214 of the user interface 21. That is, as shown in FIG. 3A, the first and the second values can be set to 10000 and 20000, respectively.

Also, the QoS alarm violation selector 215 of the user interface 21 is set up so as to output an alarm or indicate the status when the resultant value of the dynamic user core management information is greater than or less than the threshold value.

Sequentially, the arithmetic unit stores the dynamic user core management information calculated from the system performance information data or the attributes in the KPI meta table 112 of the database 11 of the management server 1 after the user's selection has been completed.

The system performance collector 12 of the management server 1 collects all the system performance information data of the NE system 3 and stores the collected data in the system information collection table 111.

Simultaneously, the system performance collector 12 transmits the data collection complete message, indicating that the collection of the system performance data has been completed, to the client manager 2.

Then, the KPI query processor 22 of the client manager 2 refers to the dynamic user core management information stored in the KPI meta table 112 when the data collection complete message has been inputted from the management server 1.

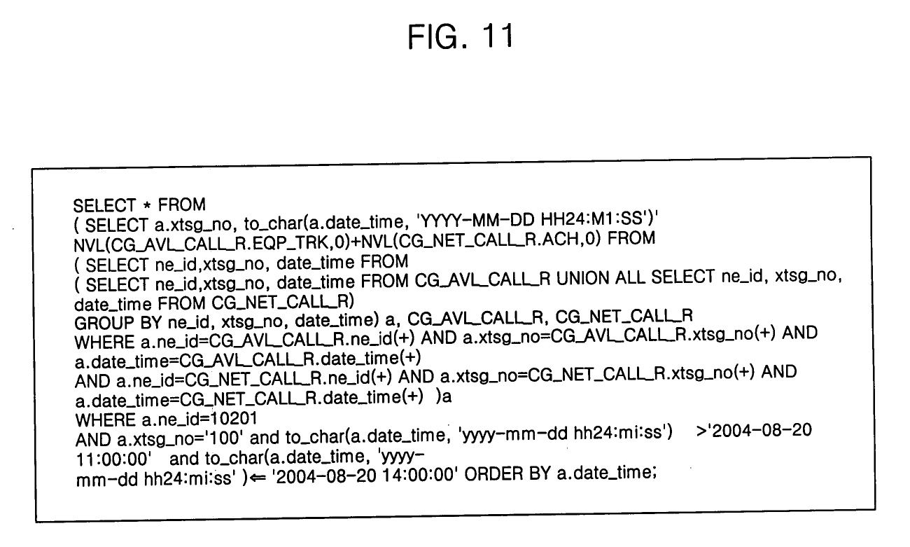

Sequentially, the KPI query processor 22 of the client manager 2 writes a query (see FIG. 11) and refers to the dynamic user core management information from the system information collection table 111 of the database 11 of the management server 1 using the query so as to selectively collect and output the system performance information data.

The resultant value of the dynamic user core management information is compared with the threshold values of the respective system performance information data so as to obtain the status value of the dynamic user core management information.

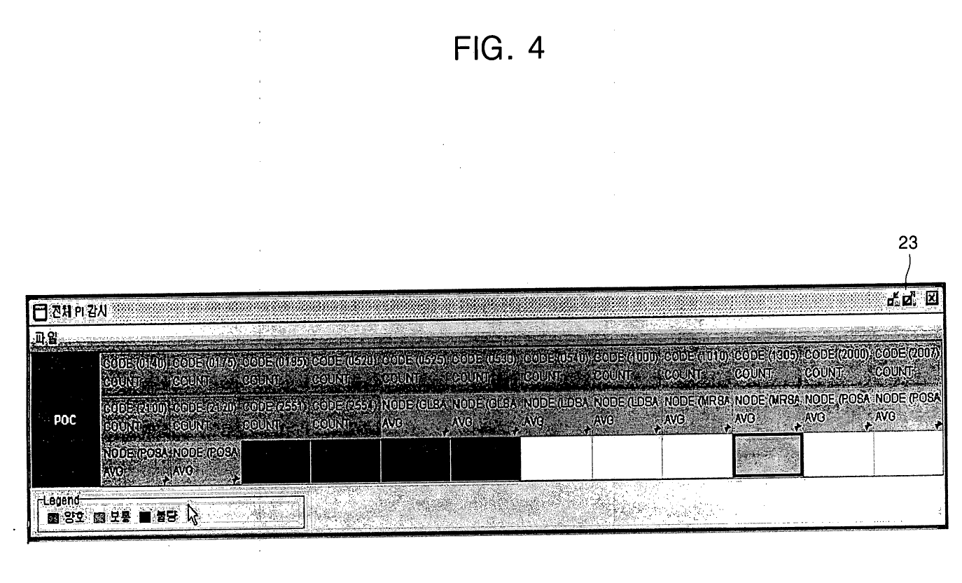

The status value of the dynamic user core management information is displayed as shown in FIG. 4.

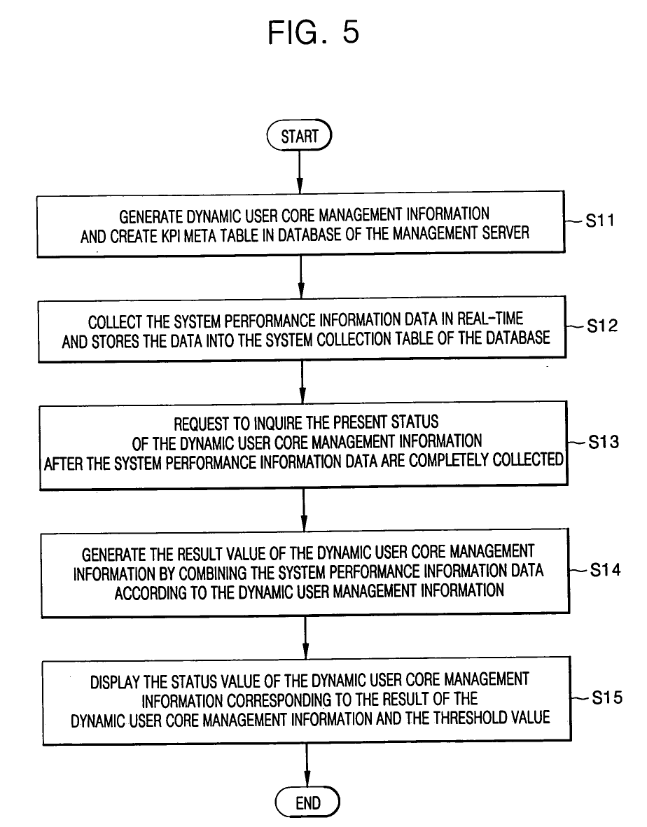

The above-implemented dynamic QoS management method is described in more detail hereinafter with reference to FIG. 5.

Firstly, the dynamic user core management information is generated by combining the different system performance information data or their attributes via the four rules of arithmetic and the KPI meta table 112 is generated in the database 11 of the management server 1 at step S11. The dynamic user core management information includes the threshold value of the system performance information data.

At step S11 for storing the dynamic user core management information, when the resultant value of the dynamic user core management information is greater than or less than the threshold value, the QoS alarm violation selector 215 is set so as to output an alarm or indicate the status, the macro expression of the dynamic user core management information is stored or modified, or the title of “user core management information” and its internal name is displayed to the operator.

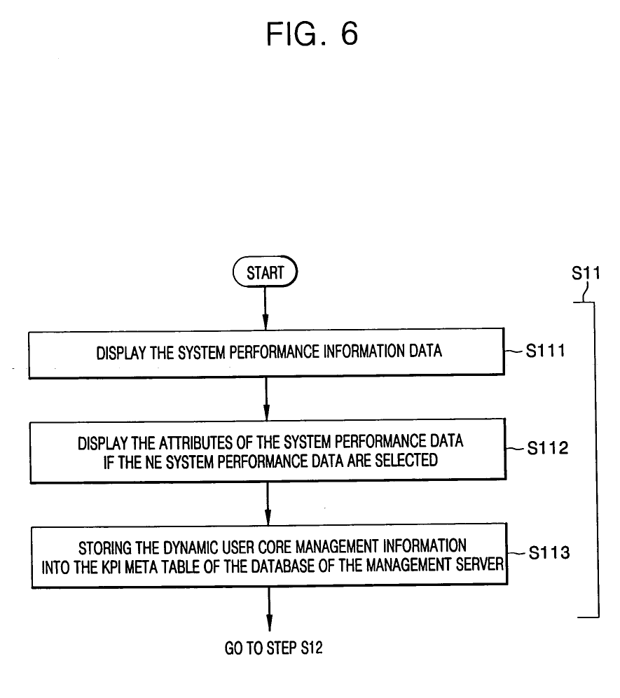

The operation of step S11 is described hereinafter in more detail with reference to FIG. 6.

Firstly, the system performance information data is displayed such that the user selects the performance information data of the NE system 3 at step S111.

Next, if the performance information data of the NE system 3 is selected from the first region, the sub-attributes of the selected performance information data are displayed at step S112.

Sequentially, the dynamic user core management information generated by combining the different system performance information data selected by the user via the four rules of arithmetic are stored in the KPI meta table 112 of the database 11 of the management server 1 at step S113.

The system performance information data is collected from the NE system 3 in real-time and then stored in the system collection table of the database 11 at step S12. The system performance information data has an XML file format.

After the system performance information data has been completely collected, an inquiry as to the present status of the dynamic user core management information is issued at step S13. After the dynamic user core management information generated from the KPI meta table 112 by the inquiry, the system performance information data is combined according to the dynamic user core management information and the resultant value of the dynamic user core management information is outputted at step S14. The query inquiring the dynamic user core management information is shown in FIG. 11.

Sequentially, the resultant value of the dynamic user core management information is compared with the threshold value and the status value corresponding to the dynamic user core management information is displayed at step S15. The status level of the dynamic user core management information is displayed as “bad” when the resultant value is greater than the first threshold value, “normal” when the resultant value is between the first and second threshold values, and “good” when the resultant value is less than the second threshold value.

A dynamic QoS management apparatus and method according to the second embodiment of the present invention is described hereinafter with reference to the accompanying drawings.

The dynamic QoS management apparatus and method according to the second embodiment of the present invention includes an NE system 3, a management server 1, and a client manager 2.

The management server 1 includes a database 11, a system performance collector 12, and a QoS alarm event detector 13. The management server 1 stores the system performance information data collected from the NE system, the dynamic user core management information (Key Performance Indicator) combined according to the user's selection, and the QoS error data in the respective table of the database 11, and outputs an alarm when a QoS error occurs.

The database 11 of the management server 1 includes a system information collection table 111 for storing the system performance information data, a KPI meta table 112 for storing the dynamic user core management information generated by the client manager 2, and an error management table for storing the QoS error data. The KPI meta table 112 of the database 11 includes at least one of a table name, a table list, and a logical location, as shown in FIG. 10.

The system performance collector 12 collects the performance information data from the NE system 3 in real-time and stores the collected performance information data in the system information collection table 111 of the database 11. After the collection of the system performance information data has been completed, the system performance collector 12 transmits a “data collection completion signal” to the client manager 2. The system performance collector 12 collects the system performance information data in an XML file format.

Also, the QoS alarm event detector 13 of the management server 1 receives status information, i.e., “user core management information” from the client manager 2 and generates a QoS error alarm if the status information indicates a QoS error and simultaneously stores/deletes/modifies the status of the user core management information within an error management table of the database 11.

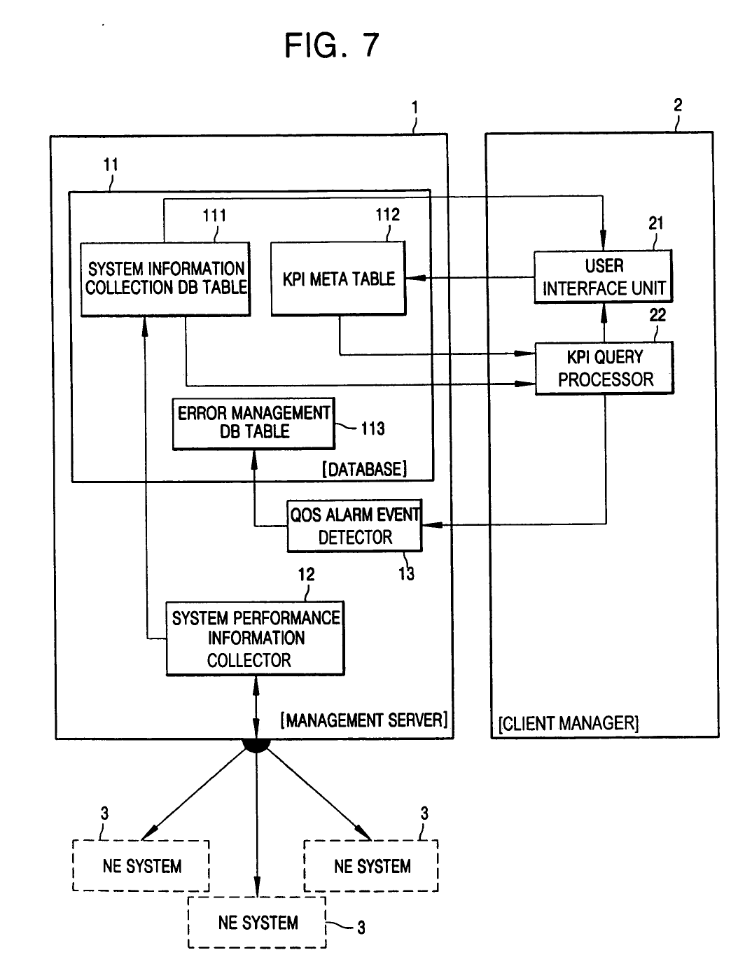

The client manager 2 stores the dynamic user core management information combined through the user's selection in the KPI meta table 112, generates the system performance information required by the user with reference to the KPI meta table 112, and transmits the “dynamic user core management information” status information to the management server 1. As shown in FIG. 7, the client manager 2 includes the user interface 21 and the KPI query processor 22. The dynamic user core management information includes the threshold value of the system performance information data.

The user interface 21 of the client manager 2 combines different system performance information data according to the user selection on the various information associated to the user core management information and stores the combined information in the management server 1. The user interface 21 includes a display 211, an arithmetic unit 212, an arithmetic register 213, a threshold configuration unit 214, a QoS alarm violation selector 215, and a KPI display 216. The user interface 21 is a GUI displaying the performance information of the NE system 3 from the management server 1.

The display 211 of the user interface 21 includes a first region for displaying the system performance information data and their attributes and high level performance data of the NE system such that the user can select the different system performance information data, the attributes, and the high level performance data; and a second region for displaying low level attributes of the system performance information data displayed on the first region.

The arithmetic unit 212 of the user interface 21 performs arithmetic processing of the attributes of the system performance information data selected by the user. Also, the threshold configuration unit 214 of the user interface 21 configures at least one threshold value so as to display the status of the dynamic user core management information selected by the user.

The QoS alarm violation selector 21 of the user interface 21 outputs an alarm or indicates the status when the value of the dynamic user core management information is greater than or less than the threshold value.

Also, the arithmetic register 213 of the user interface 21 stores or modifies the macro expression of the dynamic user core management information.

The KPI display 216 of the user interface 21 displays the label “user core management information” and the name used in the system to the operator.

The KPI query processor 22 of the client manager 2 selectively combines the system performance information corresponding to the dynamic user core management information received from the management server 1 and then computes the resultant value of the dynamic user core management information, after the collection of the system performance information data has been completed. The KPI query processor 22 collects the different system performance information data from the database 11 of the management server 1 using an outer join for computing the resultant value of the dynamic user core management information achieved via the arithmetic four rules. Also, the KPI query processor 22 generates a query for combining the attributes of the system performance information data by referring to the user core management information of the meta table 112 of the database 11 of the management server 1 and then collects the system performance information data corresponding to the query and stores the data in an Application Programming Interface/Java Application Resource (API/JAR) format.

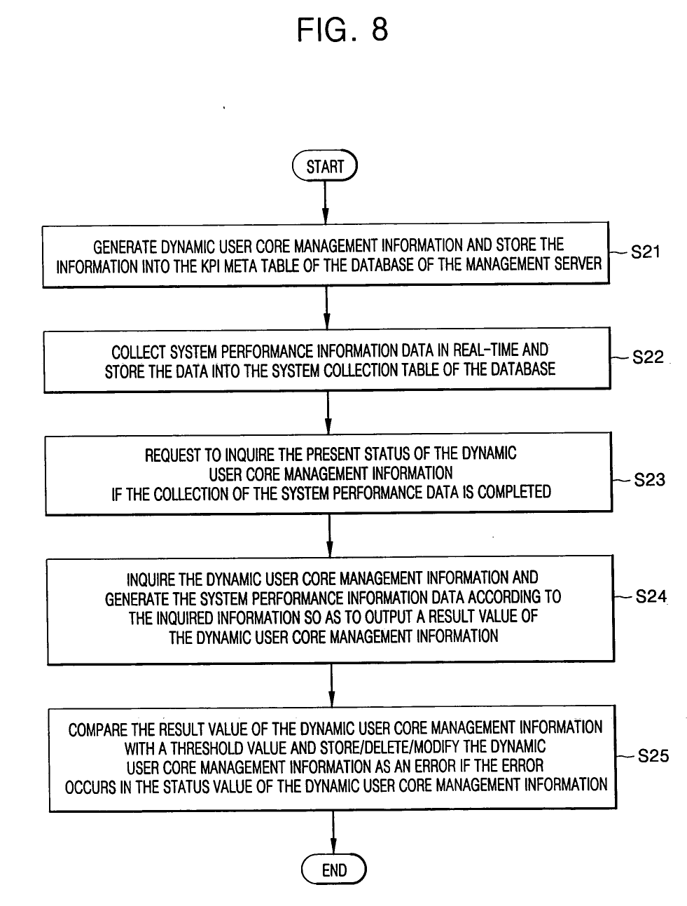

The operation of the above-structured dynamic QoS management apparatus is described hereinafter with reference to FIG. 8.

Firstly, the dynamic user core management information is generated by combining the different system performance information data or the attributes of the data and then stored in the KPI meta table 112 of the database 11 of the management server at step S21. The dynamic user core management information includes the threshold value of the system performance information data. Furthermore, when the resultant value of the dynamic user core management information is greater than or less than the threshold value, the QoS alarm violation selector is set so as to output an alarm or indicate the status, the macro expression of the dynamic user core management information is stored or modified, or the title of “user core management information” and its internal name is displayed to the operator.

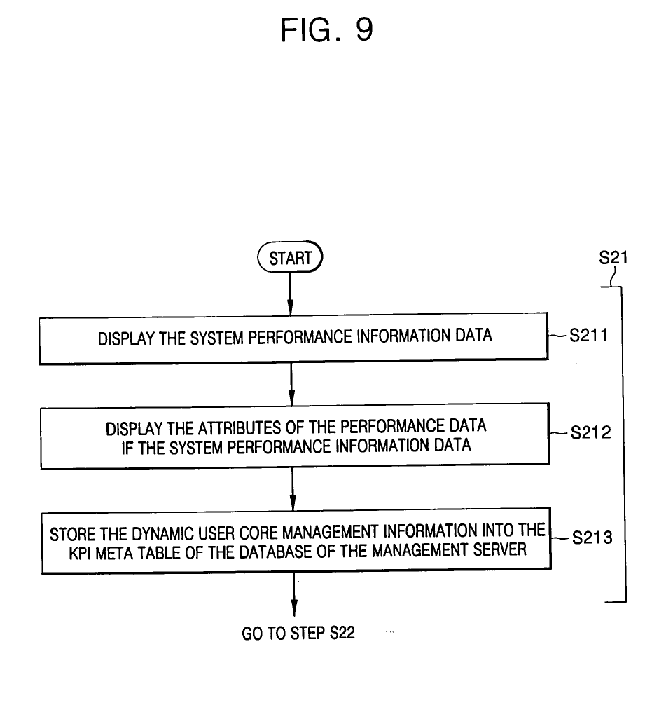

Now, the operation of the step S21 is described in more detail hereinafter with reference to FIG. 9.

Firstly, the system performance information data is displayed such that the user selects the performance information data of the NE system 3 at step S211.

Next, if the performance information data of the NE system 3 is selected from the first region, the sub-attributes of the selected performance information data are displayed at step S212.

Sequentially, the dynamic user core management information, generated by combining the different system performance information data selected by the user via the four rules of arithmetic, is stored in the KPI meta table 112 of the database 11 of the management server 1 at step S213.

The system performance information data is collected from the NE system 3 in real-time and then stored in the system collection table of the database 11 at step S22. The system performance information data has an XML file format.

After the system performance information data has been completely collected, an inquiry as to the present status of the dynamic user core management information is issued at step S13. After the dynamic user core management information is generated from the KPI meta table 112 in response to the inquiry, the system performance information data is combined according to the dynamic user core management information and the resultant value of the dynamic user core management information is outputted at step S24. The query inquiring the dynamic user core management information is shown in FIG. 11.

Sequentially, the resultant value of the dynamic user core management information is compared with the threshold values of the respective system performance information data and the dynamic user core management information is stored/deleted/modified when an error occurs in the status value of the dynamic user core management information at step S25.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

As described above, in the dynamic QoS management apparatus and method, the management for generating/modifying/deleting the new KPI by performing the four rules of arithmetic on the different data (multi DB table attributes) can be performed without stopping the system operation such that the requirements for managing the QoS with compound characteristics due to the various functions and policies recommended by different standards can be satisfied.

Also, in the dynamic QoS management apparatus and method, the essential KPIs are dynamically generated, deleted, and modified without stopping the operation of the QoS management apparatus such that it is possible to improve the operation convenience.

Also, the dynamic QoS management method can be adopted to any systems of a plug-in type such that it is possible to reduce the time and cost for developing the system management apparatus.

What is claimed is:

1. A dynamic Quality of Service (QoS) management apparatus comprising:
a management server having a database, the management server adapted to store system performance information data collected from a Network Element (NE) system and dynamic user core management information generated by a user's selection in a table of the database; and
a client manager adapted to generate system performance information by referring to the dynamic core management information stored in the database and to display status information corresponding to the dynamic user core management information.

2. The dynamic QoS management apparatus of claim 1, wherein the database of the management server comprises a system information collection table adapted to store the system performance information data and a KPI meta table adapted to store the dynamic user core management information generated by the client manager, and wherein the management server comprises a system performance collector adapted to store the performance information data from the NE system in real-time in the system information collection table and to transmit a data collection completion signal to the client manager after the system performance information data has been completely collected.

3. The dynamic QoS management apparatus of claim 2, wherein the KPI meta table of the database comprises at least one of a table name, a table list, and a logical location defined as an array.

4. The dynamic QoS management apparatus of claim 2, wherein the system performance collector is adapted to collect the system performance information data in an extensible Markup Language (XML) file format.

5. The dynamic QoS management apparatus of claim 1, wherein the client manager comprises:
a user interface adapted to generate different system performance information data according to the user core management information selected by the user and to store the system performance information data in the management server; and
a KPI query processor adapted to selectively combine the system performance information corresponding to the dynamic user core management information after the system performance information data has been completely collected.

6. The dynamic QoS management apparatus of claim 5, wherein the user interface is adapted to receive a resultant value of the dynamic core management information from the KPI query processor, to compare the resultant value with a threshold value, and to display a status of the dynamic user core management information as a corresponding level.

7. The dynamic QoS management apparatus of claim 1, wherein the dynamic user core management information comprises a threshold value of the system performance information.

8. The dynamic QoS management apparatus of claim 5, wherein the user interface comprises a Graphic User Interface (GUI) with NE system performance information from the management server.

9. The dynamic QoS management apparatus of claim 5, wherein the user interface comprises:
a display adapted to display the system performance data and attributes of the data to enable the user to select the different system performance information data or the attributes; and
a arithmetic unit adapted to perform four rules arithmetic between the attributes of the system performance information data selected by the user.

10. The dynamic QoS management apparatus of claim 9, wherein the display comprises:
a first region adapted to display upper performance data of the NE system to be selected by the user; and
a second region adapted to displaying attributes of the performance data upon the system performance information data being selected.

11. The dynamic QoS management apparatus of claim 5, wherein the user interface further comprises a threshold setup unit adapted to set at least one threshold value to display the status of the dynamic user core management information selected by the user.

12. The dynamic QoS management apparatus of claim 5, wherein the interface further comprises a QoS alarm violation selector adapted to output an alarm or to indicate the status upon the resultant value of the dynamic user core management information being greater than or less than the threshold value.

13. The dynamic QoS management apparatus of claim 5, wherein the user interface further comprises an arithmetic registration unit adapted to register or modify a macro expression of the dynamic user core management information.

14. The dynamic QoS management apparatus of claim 5, wherein the user interface further comprises a KPI display adapted to display a title of the user core management information and a corresponding internal name.

15. The dynamic QoS management apparatus of claim 5, wherein the KPI query processor is adapted to collect the different system performance information data from the database of the management server using an outer join and to output the result of the dynamic user core management information formed by the four rules of arithmetic.

16. The dynamic QoS management apparatus of claim 5, wherein the KPI query processor is adapted to collect the system performance information data after generating a query for retrieving the attributes of the system performance information data by referring to the user core management information of the meta table stored in the database of the management server.

17. The dynamic QoS management apparatus of claim 5, wherein the KPI query processor comprises an Application Programming Interface/Java Application Resource (API/JAR) format.

18. The dynamic QoS management apparatus of claim 5, wherein the status level of the user core management information displayed through the user interface is adapted to be classified as “bad” upon the user core management information being greater than a first threshold, as “intermediate” upon the user core management information being between the first threshold value and a second threshold value, and as “good” upon the user core management information being less than the second threshold value.

19. The dynamic QoS management apparatus of claim 5, wherein the KPI query processor is adapted to compute or acquire the resultant value of the dynamic user core management information after the data collection completion message has been inputted from the management server.

20. The dynamic QoS management apparatus of claim 1, wherein the management server further comprises a QoS alarm event detector adapted to receive the status information of the user core management information from the client manager and to generate a QoS error alarm and simultaneously store or delete or modify the status of the user core management information in an error management table of the database upon the status information indicating an error.

21. A dynamic Quality of Service (QoS) management method comprising:
generating dynamic user core management information by processing different system performance information data or attributes of the data using four rules of arithmetic and generating a KPI meta table in a database of a management server;
storing the system performance information data collected from a Network Element (NE) system in real-time into a system collection table in the database;
requesting a present status of the dynamic user core management information after the system performance information data has been completely collected;
outputting a resultant value of the dynamic user core management information by combining the system performance information data according to the dynamic user core management information created in the KPI meta table; and
displaying the status value of the dynamic user core management information corresponding to a resultant of comparison between the resultant value of the dynamic user core management information and the threshold value.

22. The dynamic QoS management method of claim 21, wherein the dynamic user core management information comprises a threshold value of the system performance information data.

23. The dynamic QoS management method of claim 21, wherein storing the dynamic user core management information comprises:
displaying the system performance information data to enable the NE system performance information data to be selected;
displaying the low attributes of the performance data upon the performance data of the NE system being selected from a first region; and
storing the dynamic user core management information generated from the different system performance information data selected by the user through the four rules of arithmetic into the KPI meta table of the database of the management server.

24. The dynamic QoS management method of claim 21, wherein the system performance information data comprises an extensible Markup Language (XML) file format.

25. The dynamic QoS management method of claim 21, wherein combining the system performance information data in the KPI meta table comprises a query.

26. The dynamic QoS management method of claim 21, wherein the level of the dynamic user core management information is classified as “bad” upon the user core management information being greater than a first threshold, as “intermediate” upon the user core management information being between the first threshold value and a second threshold value, and as “good” upon the user core management information being less than the second threshold value.

27. The dynamic QoS management method of claim 21, wherein storing the dynamic user core management information comprises:
outputting an alarm or indication upon the resultant value of the dynamic user ocre management information being greater than or less than the threshold value;
registering or modifying a macro expression of the dynamic user core management information; and
displaying the title of user core management information and an internal name of the user core management information.

28. A dynamic Quality of Service (QoS) management apparatus comprising:
a management server adapted to store system performance information data collected from a Network Element (NE) system and a dynamic user core management information Key Performance Indicator (KPI) generated by a user's selection, to store QoS error data in a respective table of a database, and to generate an alarm upon a QoS error occurring; and
a client manager adapted to store the dynamic user core management information generated by the user's selection, to generate system performance information, requested by the user, referring to the KPI meta table after the system performance information data has been completely collected, and to transmit status information of the dynamic user core management information to the management server.

29. The dynamic QoS management apparatus of claim 28, wherein the management server comprises:
a database having a system information collection table adapted to store the system performance information data and a KPI meta table to store the dynamic user core management information generated by the client manager;
a system performance collector adapted to store the performance information data from the NE system in real-time in the system information collection table and to transmit a data collection completion signal to the client manager after the system performance information data has been completely collected; and
a QoS alarm event detector adapted to receive the status information of the user core management information from the client manager, to generate a QoS error alarm upon the status information indicating an error, and to store or delete or modify the status of the user core management information in the error management table of the database.

30. The dynamic QoS management apparatus of claim 28, wherein the client manager comprises:
a user interface adapted to generate different system performance information data according to the user core management information selected by the user and to store the system performance information data in the management server; and
a KPI query processor adapted to selectively combine the system performance information corresponding to the dynamic user core management information after the system performance information data has been completely collected.

31. The dynamic QoS management apparatus of claim 30, wherein the user interface comprises:
a display adapted to display the system performance data and attributes of the data to enable the user to select the different system performance information data or the attributes; and
a arithmetic unit adapted to perform four rules arithmetic between the attributes of the system performance information data selected by the user.

32. The dynamic QoS management apparatus of claim 31, wherein the display comprises:
a first region adapted to display upper performance data of the NE system to be selected by the user; and
a second region adapted to display attributes of the performance data upon the system performance information data being selected.

33. A dynamic Quality of Service (QoS) management method comprising:
generating dynamic user core management information by processing different system performance information data or attributes of the data using four rules of arithmetic and storing the dynamic user core management information in a Key Performance Indicator (KPI) meta table of a database of a management server;
storing the system performance information data collected from a Network Element (NE) system in real-time in a system collection table in the database;
requesting a present status of the dynamic user core management information after the system performance information data has been completely collected;
outputting a resultant value of the dynamic user core management information by combining the system performance information data according to the dynamic user core management information created in the KPI meta table; and
storing or deleting or modifying the dynamic user core management information in an error management table as an error upon the status value of the dynamic user core management information as a result of the comparison between the resultant value of the dynamic user core management information and a threshold value indicating the error.

34. The dynamic QoS management method of claim 33, wherein storing the dynamic user core management information comprises:
displaying the system performance information data to enable the NE system performance information data to be selected;
displaying the low attributes of the performance data upon the performance data of the NE system being selected from a first region; and
storing the dynamic user core management information generated from the different system performance information data selected by the user using the four rules of arithmetic in the KPI meta table of the database of the management server.

35. The dynamic QoS management method of claim 33, wherein storing the dynamic user core management information comprises:
outputting an alarm or indication upon the resultant value of the dynamic user core management information being greater than or less than the threshold value;
registering or modifying a macro expression of the dynamic user core management information; and
displaying the title of user core management information and an internal name of the user core management information.
